(19) United States
(12) Patent Application Publication
(10) Pub. No.: US 2018/0321477 A1
(43) Pub. Date: Nov. 8, 2018

(54) LIGHT-EMITTING UNIT WITH FRESNEL OPTICAL SYSTEM AND LIGHT-EMITTING APPARATUS AND DISPLAY SYSTEM USING SAME

(71) Applicant: Corning Incorporated, Corning, NY (US)

(72) Inventors: Dmitri Vladislavovich Kuksenkov, Elmira, NY (US); James Fredric Munro, Ontario, NY (US)

(21) Appl. No.: 15/773,977

(22) PCT Filed: Nov. 3, 2016
(86) PCT No.: PCT/US16/60266

§ 371 Date: May 4, 2018

Related U.S. Application Data
(60) Provisional application No. 62/251,364, filed on Nov. 5, 2015.

(51) Int. Cl. G02B 19/00; G02B 5/00; G02F 1/1335

(52) U.S. Cl. CPC G02B 19/0061; G02B 19/0009; G02B 19/0028; G02B 5/003; G02F 2001/133607; G02F 1/133526; G02F 1/133603; G02F 1/133606; G02F 1/133512

(57) ABSTRACT

A light-emitting unit is disclosed that includes a light source and a Fresnel optical system operably arranged relative thereto. The Fresnel optical system includes spaced apart upper and lower surfaces each including micro-prisms. The lower surface is closest to the light source and receives divergent light therefrom. The lower surface directs the divergent light to the upper surface as first redirected light. The upper surface then forms from the first redirected light collimated light having a uniform radiant exitance. Some of the micro-prisms on the lower surface toward the outer edge operate by both refraction and total-internal reflection while the micro-prisms closer to the center of the lower surface operate by refraction only. A light emitting apparatus is formed by an array of the light-emitting units. A display system is formed by an arrangement of the light-emitting apparatus, an image display unit and a contrast-enhancement unit.

This application claims the benefit of priority to U.S. Provisional Application No. 62/251364, filed Nov. 5, 2015, the content of which is incorporated herein by reference in its entirety.

### FIELD

This disclosure relates to light-emitting apparatus such as used for displays, and more particularly to a light-emitting apparatus that includes a light-emitting unit having a Fresnel optical system, and a display system that uses the light-emitting apparatus.

### BACKGROUND

A conventional liquid crystal display (LCD) device generally includes a light-emitting apparatus and an LCD panel. Light emitted by the light-emitting apparatus passes through the LCD panel to generate an image that can be viewed by a viewer. One type of light-emitting apparatus used in LCD devices is a direct-lit backlight apparatus wherein the light directly illuminates the LCD panel from behind.

While such light-emitting apparatus for LCD displays can be made relatively efficient, there is ongoing need to improve their efficiency as well as their contrast as the performance requirements for LCD devices and display systems become more and more demanding.

### SUMMARY

An aspect of the disclosure is a light-emitting unit, comprising: at least one light source that emits divergent light; an optical system operably disposed relative to the light source, the optical system having a central lens axis, either a single lens element only or first and second spaced apart lens elements only, the optical system having: i) a lower surface adjacent and spaced apart from the light source and that receives the divergent light and forms therefrom first redirected light, and ii) an upper surface that receives the first redirected light and forms therefrom second redirected light; the lower surface having inner and outer regions defined by a normalized transition radius ρ_{T} in the range 0.6 ρ_{T}0.8, wherein the outer region includes first micro-prisms that both refract and totally-internally reflect the divergent light and wherein the inner region is smooth; and the upper surface having second micro-prisms that receive the first redirected light and form therefrom second redirected light that is substantially collimated and that has a radiant exitance that is uniform to within +/−8% of an average radiance exitance of the second redirected light.

In an example, the light-emitting unit includes a support structure that operably supports the light source and the optical system. Also in an example, the inner region R1 includes first micro-prisms, but these micro-prisms operate by refraction only.

Another aspect of the disclosure is a light-emitting unit that emits substantially collimated and substantially uniform light. The light-emitting unit includes: a support structure having a central support structure axis, an open front end that defines an output end, and an interior open at the open front end and defined by a bottom surface and at least one sidewall; a light source disposed on or adjacent the bottom surface and that emits divergent light; a single monolithic lens element arranged in the support structure interior, the lens element having: i) a central lens axis; ii) a lower surface adjacent and spaced apart from the light source and that receives the divergent light and forms therefrom first redirected light; and iii) an upper surface that resides at or adjacent the output end and that receives the first redirected light and forms therefrom second redirected light. The lower surface has a first microstructure that includes first and outer regions that are defined by a normalized transition radius ρ_{T} in the range 0.6ρ_{T}0.8, wherein the first microstructure within the inner region only refracts the divergent light while the first microstructure within the outer region both refracts and totally-internally reflects the divergent light to form the first redirected light. The upper surface has a second microstructure that receives the first redirected light and forms therefrom second redirected light that is substantially collimated and that has a radiant exitance that is uniform to within +/−8% of an average radiance exitance of the second redirected light.

Another aspect of the disclosure is a method of forming substantially collimated and substantially uniform light beam from at least one light source that emits divergent light by using a single lens element having a monolithic body with upper and lower surfaces, comprising: receiving the divergent light at the lower surface that includes inner and outer regions defined by a normalized transition radius ρ_{T} in the range 0.6 ρ_{T}0.8, and having a first microstructure in at least the outer region; forming from the divergent light first redirected light by only refracting the divergent light in the inner region and by refracting and totally internally reflecting the divergent light in the outer region, wherein the first redirected light travels through the monolithic body to the upper surface; and forming from the first redirected light second redirected light at the upper surface using a second microstructure thereon that is refractive only, and wherein the second redirected light defines the light beam and is substantially collimated and has a radiant exitance that is uniform to within +/−8% of an average radiance exitance of the second redirected light. In an example of the method, the inner region of the lower surface also includes the first microstructure. In an example, the first and second microstructures respectively comprise first and second micro-prisms.

Another aspect of the disclosure is a light-emitting apparatus that includes an array of the light-emitting units as disclosed herein.

Another aspect of the disclosure is a display device viewable by a viewer in a viewing space and that includes the light-emitting apparatus, an image display unit operably arranged immediately adjacent the light-emitting apparatus, and a contrast-enhancement unit operably arranged immediately adjacent the image display unit.

Additional features and advantages will be set forth in the following detailed description, and in part will be readily apparent to those skilled in the art from that description or recognized by practicing the embodiments as described herein, including the detailed description that follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic partially exploded side view of an example display device that includes the light-emitting apparatus disclosed herein;

FIGS. 2A and 2B are top-down views of example light-emitting apparatus each including an array of light-emitting units having in one example a support structure with a square cross-sectional shape (FIG. 2A) and in another example a support structure with a round cross-sectional shape (FIG. 2B);

FIG. 3A is a cross-sectional view of an example light-emitting unit showing an Fresnel optical system that includes a two-sided Fresnel lens spaced apart from the light source and emitting a substantially collimated light beam;

FIG. 3B is similar to FIG. 3A and shows an example embodiment wherein the Fresnel optical system includes two spaced apart Fresnel lens elements;

FIGS. 4A through 4C are close-up cross-sectional views of a portion of the lower surface of the Fresnel optical system, illustrating the respective surface configurations (microstructure) for an outer region that operates by refraction and total-internal reflection (TIR) and an inner region that operates by refraction only;

FIG. 5A is similar to FIG. 3A and shows the optical paths of idealized light rays from the light source to the output end of the light-emitting unit for the case where there is no optical loss from the upper and lower surfaces, to illustrate a main design principle of the optical system wherein the lower surface forms uniform but non-collimated light at the upper surface, which is configured to then collimate the light to form a uniform, collimated light beam;

FIG. 5B is similar to FIG. 5A and shows the optical paths of computer-simulated light rays from the light source to the output end of the light-emitting unit, including accounting for optical loss at the upper and lower surfaces, wherein the light rays do not all have equal intensity;

FIG. 5C is similar to FIG. 5B and shows the outputted light beam with light rays that have equal intensity and illustrating how the outputted light beam of FIG. 5B actually has the idealized form shown in FIG. 5A even when accounting for optical losses at the upper and lower surfaces;

FIG. 6 is a close-up cross-sectional view of the upper surface of the optical system of the light-emitting unit, along with an image display unit and a contrast-enhancement unit arranged adjacent thereto as shown in FIG. 1, and illustrating how the collimated rays are directed through the apertures of the contrast-enhancement unit;

FIG. 7A is similar to FIG. 3A and illustrates an example embodiment wherein the light source includes a collector optical system arranged adjacent the light source upper surface;

FIG. 7B is similar to FIG. 7A and includes a computer-simulated ray trace of light as it travels from the output end of the collector optical system to the output end of the light-emitting unit;

FIG. 8 is similar to FIG. 3A and shows an example light-emitting unit that includes two spaced apart light sources;

FIG. 9A is a plot of the slope S (degrees) versus the normalized radial coordinate p for the refractive micro-prisms that reside in the first (inner) region of the lower surface for an example optical system;

FIG. 9B is similar to FIG. 9A and shows the slope S for the refractive +TIR micro-prims for the lower surface for the example Fresnel optical system; and

FIG. 9C is similar to FIG. 9A and shows the slope S for the refractive micro-prisms for the upper surface for the example Fresnel optical system.

### DETAILED DESCRIPTION

Reference is now made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

In the discussion below, the variable “r” represents a radial coordinate measured perpendicular to the lens axis AL of optical system 218. The parameter “R” represents the radius of the optical system 218 or lens element 220 or lens elements 220U and 220L of the optical system. The variable p represents a normalized radial coordinate and is defined as p =r/R or ρ=x/X, where “X” represents the x-dimension of the optical system.

Also in the discussion below, for ease of explanation, for certain light such as light 210, light 211 and light 212 introduced and discussed below, such “light” is also referred to as “light beam” or “light ray” or “light rays,” depending on the context of the discussion.

In the discussion below, the term “substantially collimated” means in an example that at least 80% of the light rays of outputted light beam 212 have an angular divergence of no more than ±5° in at least one plane, not including light rays that are associated with scattered light. In some cases, reference to collimated light can include light that is collimated only in one plane, such as associated with a cylindrical optical system, while in other cases it can include collimation in two orthogonal planes, such as associated with a non-cylindrical (e.g., spherical) optical system.

Display Device

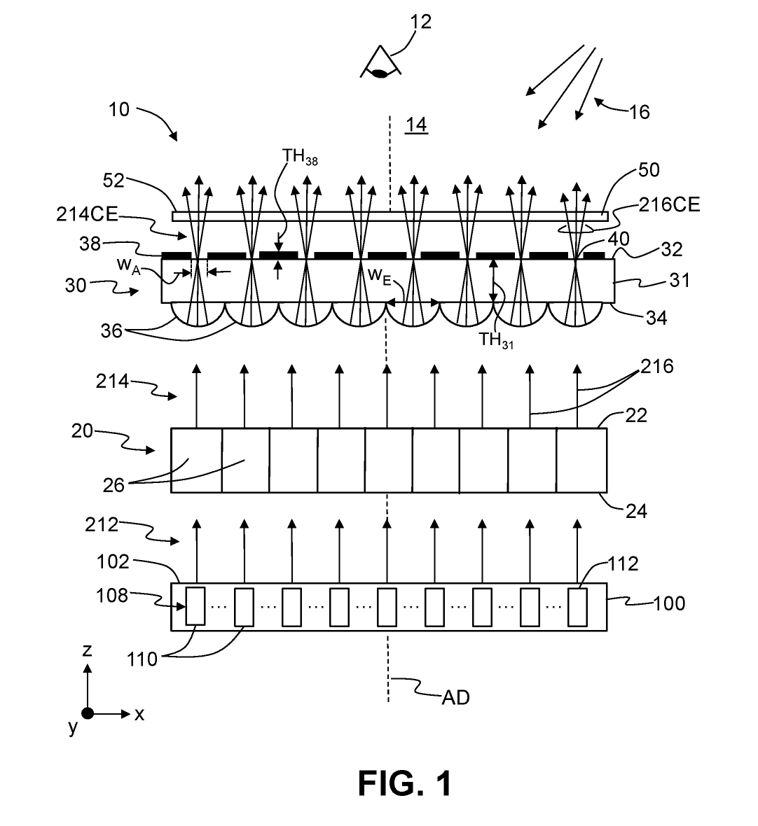

FIG. 1 is a schematic partially exploded side view of an example display device 10 having a central display axis AD. The display device 10 includes a light-emitting apparatus 100 that has a front side 102 and that includes an array 108 of one or more light-emitting units 110. Each light-emitting unit 110 has a front end 112 from which is emitted substantially collimated light 212. Details of light-emitting apparatus 100 and light-emitting units 110 are presented in greater detail below. The collimated light 212 can be used to form backlight illumination for display device 10.

The display device 10 further includes an image display unit 20 having front and back sides 22 and 24 and which is arranged adjacent the front side 102 of light-emitting apparatus 100. The display device 10 also includes a contrast-enhancement unit 30 having front and back sides 32 and 34 and which is arranged adjacent the front side 22 of image display unit 20. In an example, display device 10 includes a transparent cover 50 having an upper surface 52 and arranged adjacent the upper surface 32 of the contrast enhancement device 30. In this configuration, light-emitting apparatus 100 serves as a direct-lit backlight.

A viewer 12 is shown viewing display device 10 from a viewing space 14 adjacent the upper surface 52 of the transparent cover. In an example, viewing space 14 includes ambient light 16 that is incident upon display device 10.

It will be understood that adjacent components of display device 10 can be operably arranged relative to each other in a number of ways, including adhered to each other (e.g., by an optically clear adhesive), secured within a bezel or frame (with or without an air gap therebetween), or coupled by another suitable coupling mechanism known and used in the art.

The image display unit 20 is positioned such that collimated light 212 emitted from light-emitting apparatus 100 is incident on the image display unit. The image display unit 20 comprises an array of display pixels 26. For example, the array of display pixels 26 is two-dimensional (2D) with suitable x- and y-dimensions (e.g., width and length) to display an image of a desired size. Each display pixel 26 comprises a light valve configured to control the passage of collimated light 212 therethrough to form display light 214.

In an example, image display unit 20 comprises an LCD panel, and the array of display pixels 26 comprises an array of LCD cells. Each LCD cell is configured to open and close to control the passage of collimated light 212 therethrough. In some embodiments, each display pixel 26 is divided into a plurality of sub-pixels (not shown), each associated with a dedicated display color component (e.g., red, green, or blue), so that color images can be generated by using adjacent red, green, and blue sub-pixels. In some embodiments, collimated light 212 passes through display pixels 26 of image display unit 20 so that display light 214 comprises corresponding image pixels 216 that define a viewable image that can be viewed by viewer 12. In some embodiments, image display unit 20 comprises one or more polarizing layers, e.g., input and output polarizers (not shown).

Contrast-enhancement unit 30 is positioned to receive the display light 214 from image display unit 20. In some embodiments, contrast-enhancement unit 30 is configured as a contrast-enhancement sheet. The contrast-enhancement sheet can be substantially flat or planar. Alternatively, the contrast-enhancement sheet can be non-planar. For example, the contrast-enhancement sheet can be curved, rolled (e.g., into a tube), bent (e.g., at one or more edges), or formed into another non-planar configuration. In an example, contrast-enhancement unit 30 includes at least one transparent substrate 31 that defines the upper and lower surfaces 32 and 34 of the contrast-enhancement unit. In an example, substrate 31 has a thickness TH₃₁ in the range 50 μm≤TH₃₁≤3 mm. In an example, the upper surface 32 of substrate 31 can have a surface relief diffuser texture (not shown), which can cause additional spreading of display light 214 passing through apertures 40 (introduced and discussed below), as well as imparting a texture to light-absorbing layer 38 that can facilitate absorption of ambient light 16. The upper surface 32 of substrate 31 can also have microstructure (not shown) that, when coated with light-absorbing layer 38, acts to trap ambient light 16 and further reduce ambient light back-reflectance.

In an example, the lower surface 34 of contrast-enhancement unit 30 supports an array of optical elements 36 while the upper surface 32 supports a light-absorbing layer 38 that includes an array of apertures 40. The apertures 40 are axially aligned with optical elements 36. For example, each optical element 36 is axially aligned with at least one aperture 40. In an example, apertures 40 have a width in the range 5μm≤w_{A}≤500 μm. In examples, apertures 40 can be formed in light-absorbing layer 38 using a lithography process or an ablation process. In an example, light-absorbing layer 38 has a thickness TH₃₈ in the range 0.5 μm≤TH₃₈≤100 μm. The apertures 40 can have any reasonable shape, including round, elliptical, square and rectangular.

In some embodiments, optical elements 36 comprise microlenses. The microlenses can be configured as cylindrical or acylindrical lenticular lenses, spherical lenses, aspherical lenses, another suitable lens shape, or combinations thereof. For example, in some embodiments, the microlenses are configured as lenticular lenses extending at least partially across a width and/or a length of the contrast-enhancement unit 30. In other examples, the microlenses are configured as spherical lenses dispersed about the width and/or length of the contrast-enhancement unit 30 (e.g., in a 2D array). Additionally, or alternatively, optical elements 36 have a circular shape, a rectangular shape, another suitable shape, or combinations thereof. In an example, optical elements have a width w_{E} in the range 50 μm≤w_{E}≤500 μm.

The display light 214 that passes through image display unit 20 enters contrast-enhancement unit 30 at lower surface 34 and exits the contrast-enhancement unit at upper surface 32 as contrast-enhanced light 214CE. The contrast-enhanced light 214CE includes contrast-enhanced image pixels 216CE. The contrast-enhanced light 214CE passes into viewing space 14 (e.g., through transparent cover 50) and defines a viewable image for viewing by viewer 12.

In some embodiments, image display unit 20 and contrast-enhancement unit 30 are arranged such that an optical element 36 focuses an image pixel 216 of display light 214 on a corresponding aperture 40 of the contrast-enhancement unit. For example, the plurality of image pixels 216 transmitted by image display unit 20 is focused by the array of optical elements 36 on the array of apertures 40 so that the image pixels 216 pass through the apertures in the light-absorbing layer 38 to form contrast-enhanced light 214CE made up of contrast-enhanced pixels 216CE that is viewable by viewer 12.

Ambient light 16 (e.g., from the sun, room lighting, or another light source) in viewing space 14 can be incident upon the upper surface of contrast-enhancement unit 30, e.g., through transparent cover 50. In other words, ambient light 16 from outside display device 10 can be incident upon the display device on its uppermost surface. The light-absorbing layer 38 absorbs at least a portion of such ambient light 16 that falls on the light-absorbing layer outside of apertures 40. Such absorption of ambient light 16 can increase the contrast of display device 10 because the absorbed ambient light does not interfere with the contrast-enhanced light 214CE emitted by contrast-enhancement unit 30 as a viewable image.

Accordingly, it can be beneficial for the area occupied by apertures 40 to be relatively small. In some embodiments, apertures 40 occupy at most about 50%, at most about 40%, at most about 30%, at most about 20%, at most about 10%, at most about 5%, or at most about 1% of the surface area of upper surface 32 of light-absorbing layer 38. Thus, in an example, most of the surface area of light-absorbing layer 38 is occupied by light absorbing material to absorb ambient light 16 and increase the contrast of display device 10.

Light-Emitting Apparatus

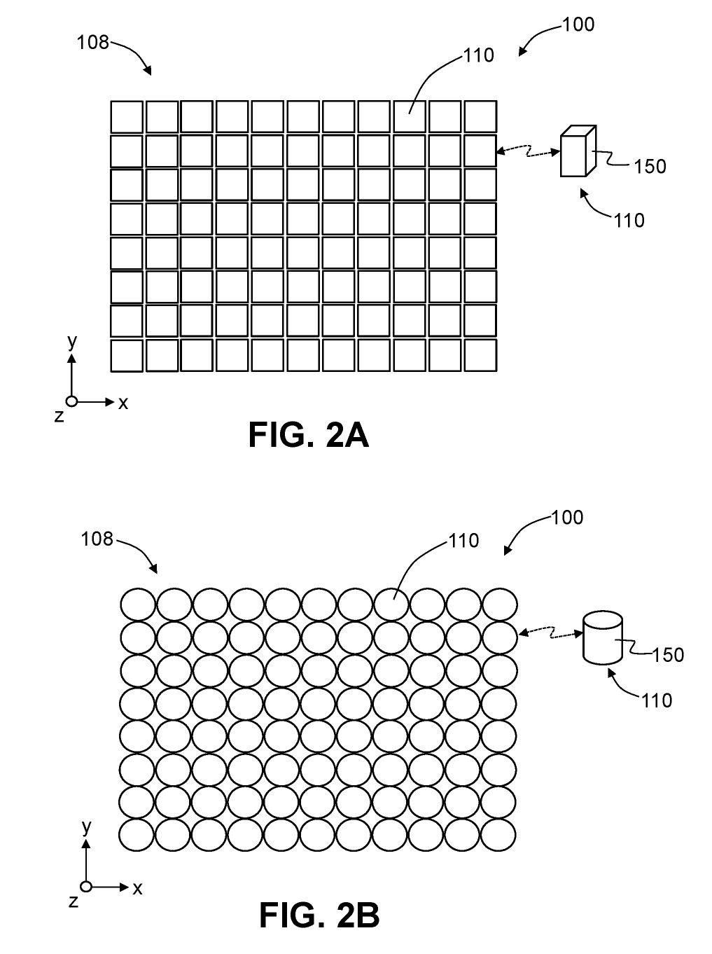

FIG. 2A and FIG. 2B are top-down views of examples of light-emitting apparatus 100 showing different configurations for light-emitting units 110 in array 108. In FIG. 2A, example light-emitting units 110 are shown as having a square cross-sectional shape and being in the form of a “square cylinder” (or more accurately, a “rectangular cuboid”) as defined by an example support structure 150, as shown in the close-up inset. In FIG. 2B, example light-emitting units 110 are shown as having a circular cross-sectional shape and generally being in the form of a round cylinder as defined by an example support structure 150, as shown in the close-up inset.

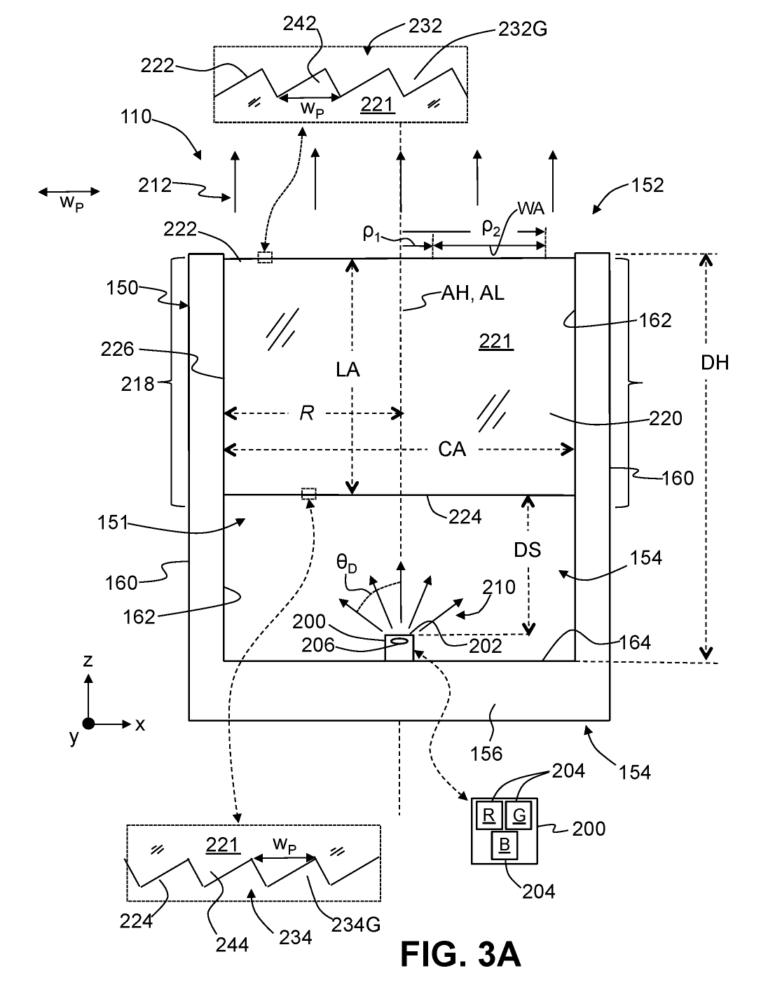

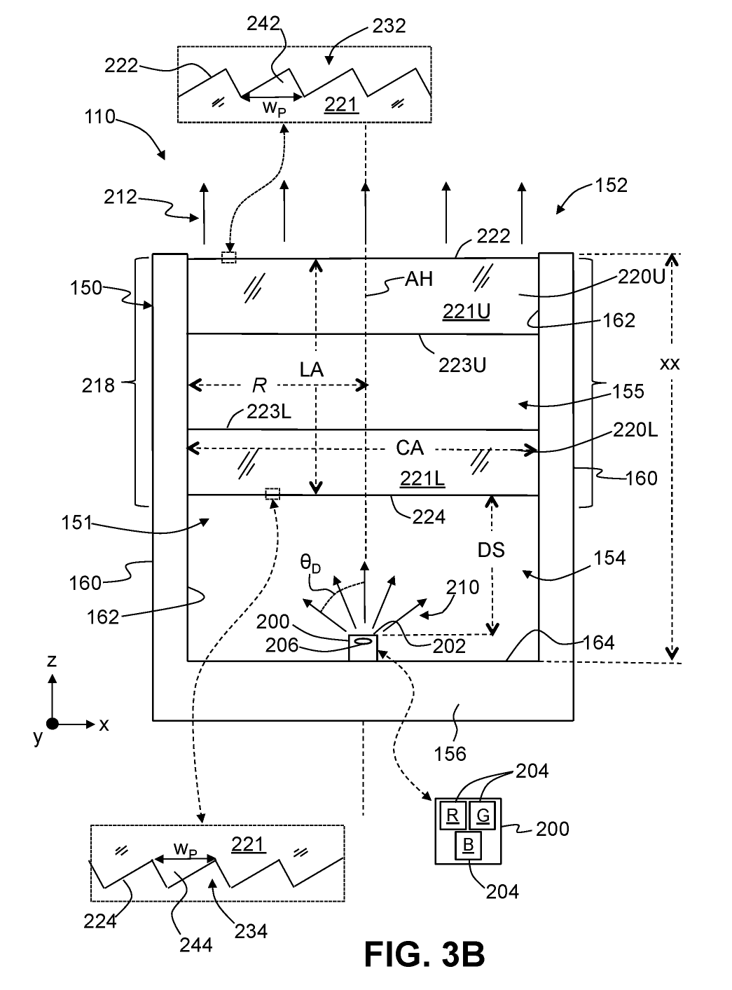

FIG. 3A is a close-up cross-sectional view of an example light-emitting unit 110. In an example, light-emitting unit 110 includes the aforementioned support structure 150. In an example, support structure 150 has a central axis AH and an interior 151 that is open at a front end 152. The front end 152 is also referred to herein as the “output end” because collimated light 212 is outputted from support structure 150 at this end. Support structure 150 includes an end wall 156 and at least one sidewall 160. The at least one sidewall 160 has at least one sidewall inner surface 162 while the end wall 156 defines a bottom surface 164. Thus, open interior 151 of support structure 150 is defined by the at least one sidewall inner surface 162 and bottom surface 164. The axial distance from bottom surface 164 to the front or output end 152 of support structure 150 is denoted DH and in an example is in the range 5 mm≤DH≤100 mm. Other forms of support structure 150 can also be employed to support the main components of the light-emitting unit 110, namely light source 200 and Fresnel optical system 218, as introduced and described below. In an example, support structure 150 defines a housing.

The light-emitting unit 110 includes a light source 200, which in an example can be arranged on or adjacent bottom surface 164 of interior 151 of support structure 150 and along the support structure central axis AH. The light source 200 has an upper surface 202 from which light 210 is emitted. The light source 200 can be a light-emitting diode (LED), or an array of LEDs. As shown in the close up inset, an example light source 200 can comprise one or multiple light-emitting elements 204, such as R, G and B light-emitting elements that respectively emit red, green and blue light.

The emitted light 210 can have a broad emission distribution (e.g., Lambertian). In another example, light source 200 can include a small lens 206 that serves to reduce the divergence of light 210 upon leaving the light source, i.e., causes the light to have a narrower emission distribution than if the microlens element were absent. The emitted light 210 is generally divergent, with the amount of divergence measured in one example by a divergence half-angle θ_{D}.

The light-emitting unit 110 also includes the aforementioned Fresnel optical system (hereinafter, “optical system”) 218 that is spaced apart from light source 200. In an example, optical system 210 is operably disposed within interior 151 of support structure 150. In an example, optical system 218 consists of a single lens element 220 having a body 221 of refractive index n _{L}, an upper surface 222, an opposite lower surface 224 and an outer edge 226. The upper and lower surfaces 222 and 224 are generally parallel to one another and are generally planar, though each includes respective microstructures 232 and 234 (see top and bottom close-up insets in FIG. 3A). The design of optical system 218 and the example lens element 220 is discussed in greater detail below. The upper and lower surfaces 222 and 224 define the upper and lower surfaces of optical system 218.

The optical system 218 is arranged within interior 151 such that lower surface 224 is adjacent but spaced apart from the upper surface 202 of the light source 200 by an axial distance DS. In one example, distance DS is in the range 2 mm≤DS≤25 mm while in another example is in the range 5 mm≤DS 15 mm. In an example, the upper surface 222 of optical system 218 is substantially co-planar with the output end 152 of support structure 150. Further in an example, outer edge 226 of lens element 220 resides immediately adjacent if not in intimate contact with sidewall inner surface 162 of support structure 150. The optical system 218 thus defines an air space 154 within interior 151 between upper surface 202 of light source 200 and the lower surface 224 of lens element 220.

The optical system 218 also has a lens central axis (“lens axis”) AL, an axial length LA measured between the upper and lower surfaces 222 and 224, and a width or clear aperture CA. In an example, the axial length LA is in the range 5 mm≤LA≤20 mm and the clear aperture CA is in the range 12 mm≤CA≤100 mm. In an example, the lens axis AL and the support structure central axis AH are co-axial. The lens element 200 also has a radius R measured radially outward from the lens axis AL, so that CA=2R, or R=CA/2. In an example where optical system 218 is cylindrical, R=X and lens axis AL lies in a central plane. In an example, the lens axis AL is also the optical system axis.

In an example, lens element 220 has a body 221 that is monolithic, i.e., made of a single isotropic material, so that the refractive index n_{L} is substantially constant within the body. In such an example, the axial length LA of optical system 218 is equal to the axial thickness of body 221 of lens element 220. In another example, lens element 220 can be made of more than one material, e.g., using layers of different material with different refractive indices n_{L1}, n_{L2}, etc. that are laminated together. Further in an example, there is no air space within body 221 between the upper and lower surfaces 222 and 224. In an example, body 221 can have a gradient refractive index, i.e., wherein n_{L} varies as a function of a radial coordinate r (or normalized coordinate ρ) as measured outward from the lens axis AL. In some cases, an optical system 218 consisting of a single monolithic lens element 220 is advantageous because the lens element can be formed in a single molding process in a manner that results in good axial alignment of the upper and lower surfaces 222 and 224.

In another example illustrated in FIG. 3B, lens element 220 is divided into first and second spaced-apart upper and lower lens elements 220U and 220L with an air space 155 therebetween and that respectively include upper surface 222 and lower surface 224. The upper and lower lens elements 220U and 220L also respectively include bodies 221U and 221L and surfaces 223U and 223L that face each other across air space 155. In the two-element example, the upper surface 222 and its opposite surface 223U can be switched so that the “upper” Fresnel surface 222 faces light source 200 and the opposite planar surface 223U faces viewer 12 and can be bonded to the lower surface 24 of image display unit 20 for improved optical efficiency as well as for convenience in fabrication of display device 10 (see FIG. 1). In the discussion below, reference is made to the embodiment of optical system 218 having the single lens element 220 as shown in FIG. 3A for convenience and ease of discussion.

In an example, the material that makes up body 221 of lens element 220 (or upper and lower lens elements 220U and 220L) is a thermoplastic material or a polymer, such as acrylic, polystyrene, or polycarbonate. In another example, body 221 is made of glass. Thus, in an example such as shown in FIG. 3A, lens element 220 is the only lens element (besides the optional small lens 206, if employed) in light-emitting unit 110, and thus in an example is the only refractive lens element that resides between the upper surface 202 of light source 200 and front end 152 of support structure 150. In the example where lens element 220 is divided into two spaced apart lens elements 220U and 220L such as shown in FIG. 3B, then in an example, there are only two such refractive lens elements in light emitting unit 110.

As noted above and as shown in the close-up insets of FIG. 3A, the upper and lower surfaces 222 and 224 of optical system 218 respectively include microstructures 232 and 234. In an example, microstructures 232 and 234 are respectively defined by small prism sections or “micro-prisms” 242 and 244, akin to a conventional Fresnel lens. In various examples, micro-prisms 242 and 244 can be linear, cylindrical, acylindrical or circular. If micro-prisms 242 and 244 are linear, then one or more light sources 200 can be arranged at a linear focal line of optical system 218. If micro-prisms 242 and 244 are circular, then light source 200 can be arranged at a focal point of optical system 218. In an example, micro-prisms 242 and 244 have a width wₚ (measured at the base) in the range from 25 μm and 150 μm.

The optical system 218 can be considered as a type of double-sided Fresnel optical system. In the single-lens embodiment of optical system 218, the single lens element 220 is a double-sided Fresnel lens element. However, unlike a conventional Fresnel lens, the micro-prisms 242 and 244 are not based on dividing up a simple spherical surface or even a simple aspherical surface. In fact, there is no usable equivalent single-surface counterpart to either of the upper or lower surfaces 222 and 224 because such surfaces would result in an unduly large lens thickness (e.g., twice the axial length LA) and in certain cases have a surface topography that would block certain regions of the surface from being illuminated.

As described in greater detail below, light 210 is mapped or redirected by lower surface 224 so that the light leaving the upper surface 222 is substantially uniform, i.e., it is not brighter in the center and dimmer at the edges, but instead has a substantially constant radiant exitance. In an example, the radiant exitance of collimated light 212 leaving upper surface 222 is uniform to within +/−10% of the average radiant exitance (e.g., the mean radiant exitance), and further in an example is uniform to within +/−8% of the average radiant exitance and even further in an example is uniform to within +/−4% of the average radiant exitance.

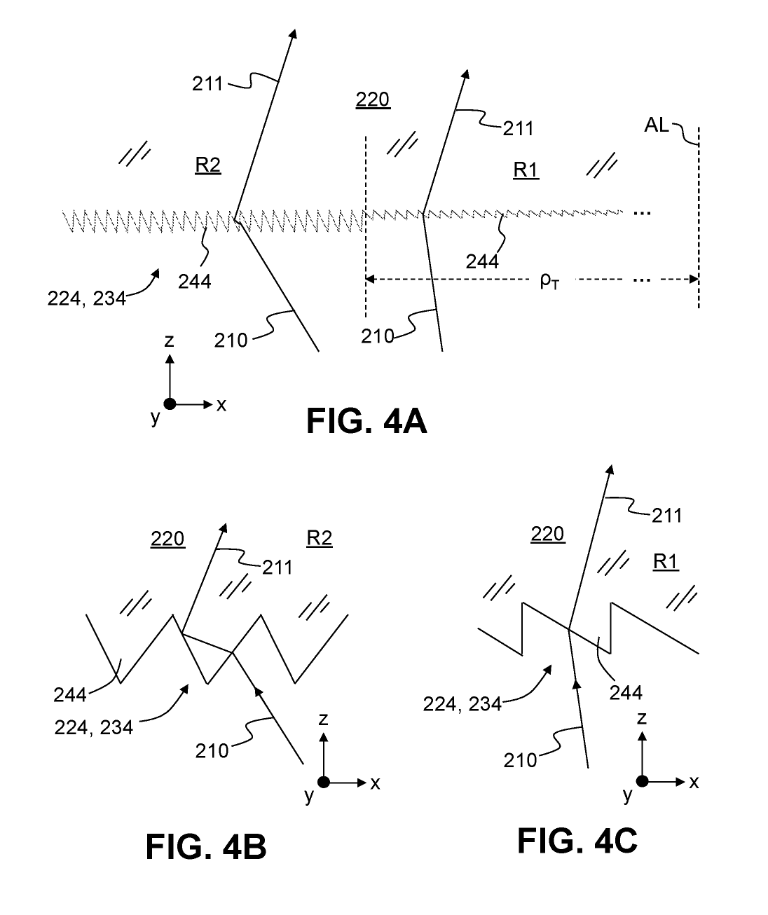

FIG. 4A is a cross-sectional view of an example microstructure 234 on lower surface 224 of optical system 218. The micro-prisms 244 of microstructure 234 are configured to be only refractive in a first or inner region R1 near the lens axis AL while the micro-prisms in a second or outer region R2 farther away from the lens axis are configured to operate using both refraction and total-internal reflection (TIR), where purely refractive micro-prisms would otherwise be optically lossy and inefficient. Thus, the first micro-prisms of the outer region comprise first outer micro-prisms, and the inner region of the lower surface comprises first inner micro-prisms. Additionally, or alternatively, the first microstructure of the outer region comprises a first outer microstructure, and the inner region of the lower surface comprises a first inner microstructure. The transition between the inner and outer regions R1 and R2 occurs at a normalized transition radius ρ_{T}, which in an example is in the range 0.6≤ρ_{T}≤0.8, and in another example is in the range 0.66≤ρ_{T}≤0.75.

In another example of microstructure 234, the portion of lower surface 224 in inner region R1 is smooth or continuous, i.e., contains no micro-prisms 244. In an example, the smooth or continuous surface 224 in inner region R1 can have a curvature (and in particular a concave curvature) that is equivalent to the microstructure 234 that would otherwise be in this region. This is possible in inner region R1 because the slopes of the micro-prisms 234 in this region are not as large as the slopes in outer region R2. Thus, in an example of optical system 218 (and in a particular example, lens element 220), lower surface 224 includes micro-prisms 244 only in outer region R2, with these prisms operating using both refraction and TIR, and with the transition radius ρ_{T} that defines the inner and outer regions R1 and R2 being defined as discussed immediately above for the case where the inner region R1 also includes micro-prisms 244.

FIG. 4B is a close-up view of example micro-prisms 244 of microstructure 234 in outer region R2 of lens element 220 showing how light 210 that has a relatively steep incident angle relative to lens axis AL (i.e., the z-direction) is redirected by a first refraction to travel in a first direction and is then redirected again by TIR to form first redirected light 211 travelling in a second direction.

FIG. 4C is a close-up view of example micro-prisms 244 of microstructure 234 in inner region R1 of lens element 220 showing how light 210 with a relatively shallow incidence angle relative to lens axis AL (i.e., the z-direction) is redirected by a single refraction to form first redirected light 211.

The redirected light 211 that travels through lens body 221 does not arrive at the upper surface as collimated light. Accordingly, microstructure 232 of upper surface 222 is configured to receive first redirected light 211 and form second redirected light 212. The second redirected light 212 is substantially collimated and substantially uniform and exits the front or output end 152 of support structure 150. The second redirected light 212 thus travels substantially in the z-direction, i.e., substantially parallel to lens axis AL, and so is also referred to herein as “collimated light” 212.

In an example, micro-prisms 242 of microstructure 232 on upper surface 222 of optical system 218 are configured to all be refractive only, i.e., none operate using TIR. Further, microstructure 232 is configured so that upper surface 222 has nearly zero optical power in the immediate vicinity of lens axis AL (e.g., within a normalized radius of ρ_{L}<0.15·ρ) since light 210 emitted by light source 200 near the lens axis (i.e., paraxial light) is already traveling generally in the z-direction, so that the corresponding first redirected light 211 also generally travels in the z-direction.

Likewise, upper surface 222 has nearly zero optical power near the lens edge 226 (e.g., within a normalized radius range ρ_{E} in the range 0.85≤ρ_{E}≤1) since the light 210 that is mapped to locations near the lens outer edge 226 as first redirected light 211 is also substantially collimated by lower lens surface 224. Thus, microstructure 232 of upper surface 222 is configured have the most optical power in an annular region AR between inner and outer normalized radii ρ₁ and ρ₂, wherein ρ₁ is in the range from 0.1≤ρ₁≤0.2 and ρ₂ is in the range from 0.8≤ρ₂≤0.9. In an example, the normalized annular width of annular region RA is WA=ρ₂−ρ₁ and is in the range 0.6≤WA≤0.8 (see FIG. 3A).

It is noted that microstructures 232 and 234 can be defined in a single direction, i.e., the y-direction or the x-direction, or can defined in two directions, i.e., both the x-direction and the y-direction. In the former case, the microstructure is linear while in the latter case the microstructure is two-dimensional, e.g., circular. Thus, in some cases as noted above, collimated light 212 may be collimated in a single plane (e.g., the x-z plane or the y-z plane) while in other cases it may be collimated in both the x-z and the y-z planes. Also, microstructures 232 and 234 and the associated micro-prisms 242 and 244 can be defined by grooves 232G and 234G formed in the upper and lower surfaces 222 and 224 respectively, using techniques known in the art.

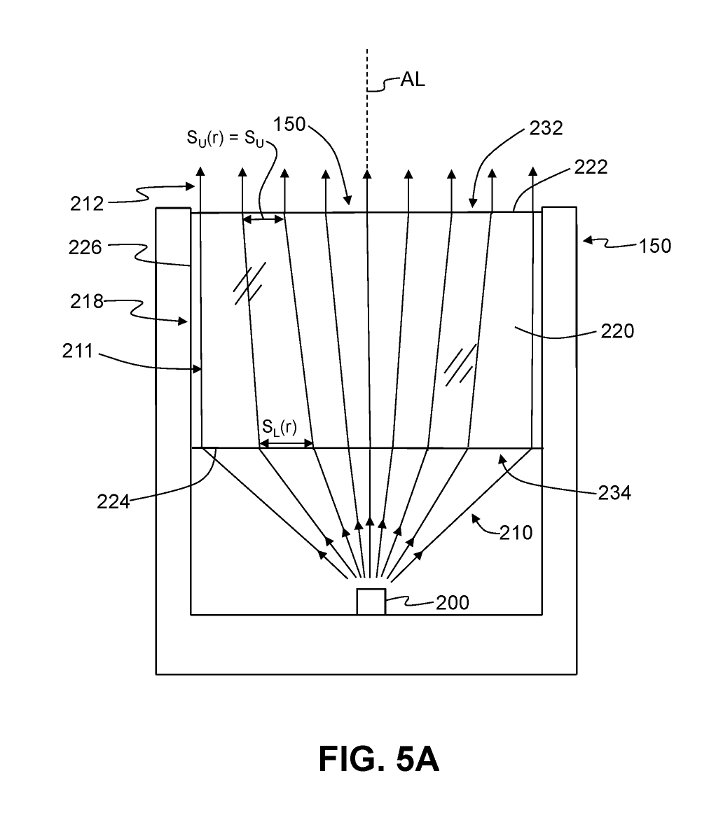

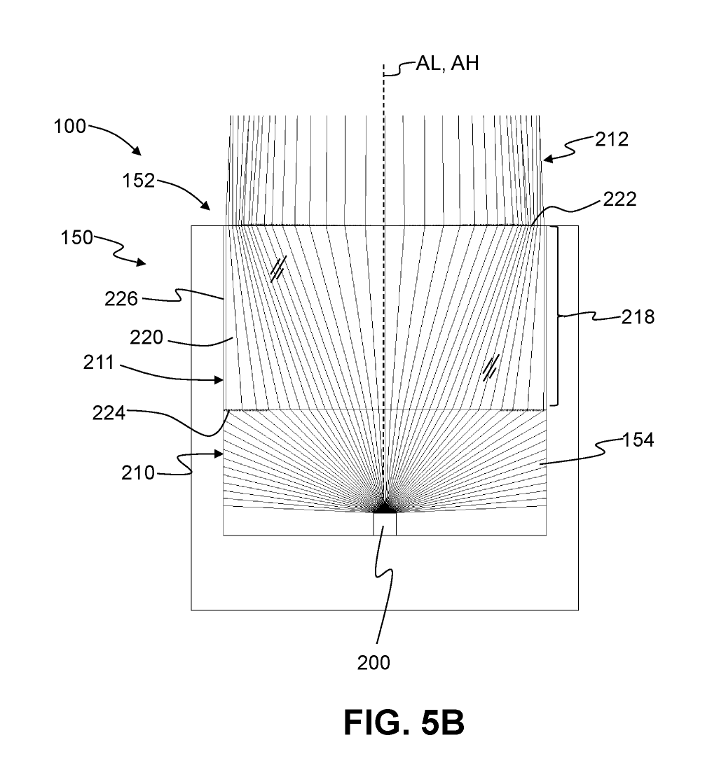

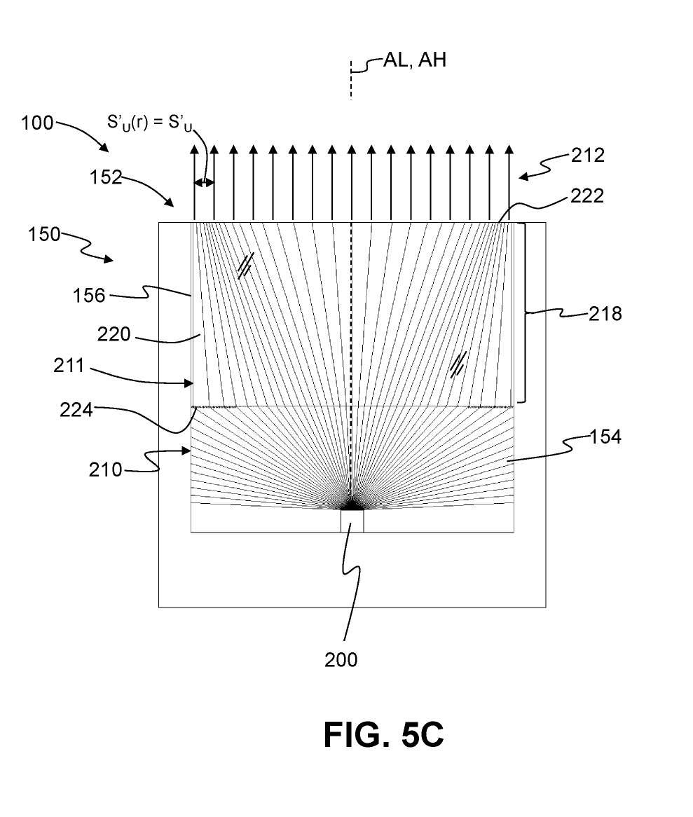

FIG. 5A is a side view of an example light-emitting unit 110 similar to that shown in FIG. 3A and includes idealized optical paths of light rays 210 emitted by light source 200. The optical paths of light rays 210, redirected light rays 211 and collimated light rays 212 assume that there is no optical loss from the upper and lower surfaces 222 and 224 as well as body 221. The light 210 from light source 200 is emitted over a relatively large angular range (e.g., ±60° for an LED light source) and need not be uniform over the angular range. The light rays 210 travel over divergent light paths and are incident upon lower surface 224. The spacing of the light rays 210 at lower surface 224 is denoted S_{L}(r). The light ray spacing S_{L}(r) varies with radius r, and in particular gets larger as r increases. This means that the light 210 is non-uniform at lower surface 224, and in fact has the highest concentration on the lens axis AL and drops off with increasing radius.

As noted above, lower surface 224 is configured via microstructure 234 therein to redirect the non-uniform light rays 210 incident thereon to form first redirected light 211 that travels to upper surface 222 in a manner that results in a substantially uniform light distribution at this surface but not a collimated light distribution. The spacing of the light rays 211 at upper surface 224 is denoted S_{U}(r). In this idealized example, the light ray spacing S_{U}(r) is substantially constant with radius, i.e., S_{U}(r)=S_{U}, with each light ray 211 representing the same amount of radiant exitance. This substantially constant spacing between the light rays 210 means that the light 211 at upper surface 222 is substantially uniform (i.e., has substantially uniform radiant exitance).

The upper surface 222 is configured via microstructure 232 to collimate first redirected light 211 to form second redirected light, i.e., collimated light 212. Thus, in this idealized example, the lower surface 224 can be said to “map” light 210 as redirected light 211 that arrives at evenly-spaced locations on upper surface 224, which in turn is configured to receive the evenly spaced but non-collimated light rays 211 to form therefrom collimated light (rays) 212. In order to accomplish this mapping, the lower surface 224 is formed to have the aforementioned inner and outer regions R1 and R2, wherein the inner region R1 includes only refractive microstructure 234 while the outer region includes both refractive and TIR microstructure.

FIG. 5B is similar to FIG. 5A and represents the non-idealized and thus more realistic case where there are losses at the upper and lower surfaces 222 and 224 (the losses within body 221 are insubstantial and are thus ignored). These losses occur due to reflections at these surfaces, which vary due to the configuration of the respective microstructures 232 and 234 of these surfaces, an in particular due to varying angles of the respective micro-prisms 242 and 242 that make up the respective microstructures 232 and 234. Thus, the light-rays spacing S_{U}(r) of redirected light 211 is not constant at upper surface 222 but instead varies to compensate for the optical losses that occur at both the upper and lower surfaces. The light rays 212 shown leaving the upper surface 222 are collimated but are shown in FIG. 5B as being more tightly concentrated closer to the outer edge 226 of lens element 220 where the losses are greatest. However, in FIG. 5B the light rays 212 leaving the upper surface 222 and generated by the computer simulation do not all have the same intensity, and the more tightly concentrated light rays also have weaker intensity, with the net effect being a substantially uniform and collimated light beam 212.

FIG. 5C is similar to FIG. 5B and represents the light rays 212 as has having equal intensity. Because the light rays 212 that leave upper surface 222 are both collimated and uniformized, the equal-intensity light rays 212 have a spacing S′_{U}(r)=S′_{U}that is substantially constant, i.e., like the spacing S_{U}(r)=S_{U} shown in the idealized example FIG. 5A.

Thus, optical system 218 of light-emitting unit 110 is not simply a collimating lens but also is light uniformizer, i.e., it includes a “built in” light uniformizing property, which in conventional light-emitting element needs to be performed with a separate light-uniformizing device or element, such as a diffuser or light homogenizer.

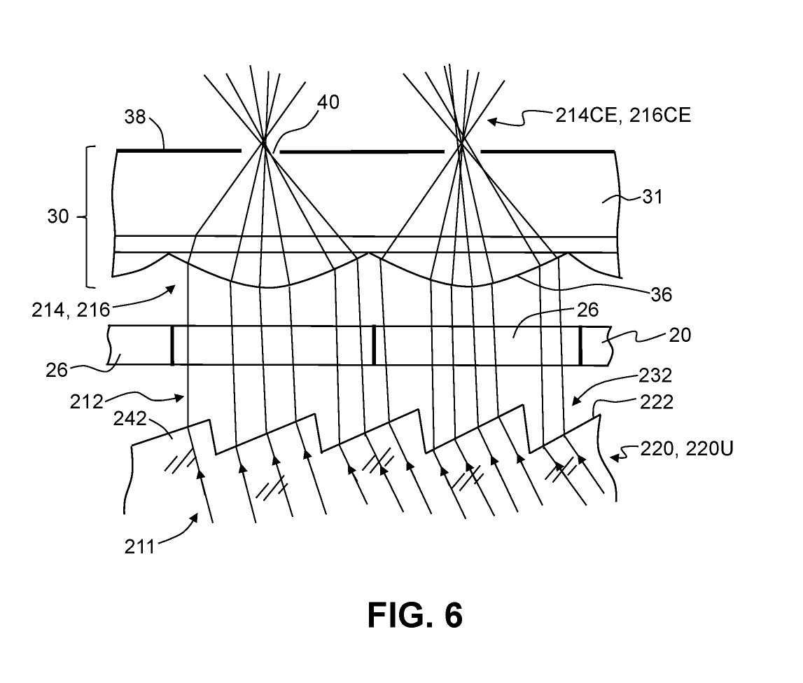

FIG. 6 is a close-up cross-sectional view of the upper surface 222 of optical system 218 of light-emitting unit 110 along with an image display unit 20 and a contrast-enhancement unit 30 arranged adjacent thereto as shown in FIG. 1. FIG. 6 shows how light 210 from lower surface 224 (see FIG. 3A) is directed as redirected light 211 to upper surface 222, which forms collimated light 212. The collimated light 212 passes through display pixels 26 of display unit 20 to form display light 214 and image pixels 216. The display light 214 and image pixels 216 then pass through the contrast-enhancement unit 30 to form contrast-enhanced display light 214CE and contrast-enhanced image pixels 216CE.

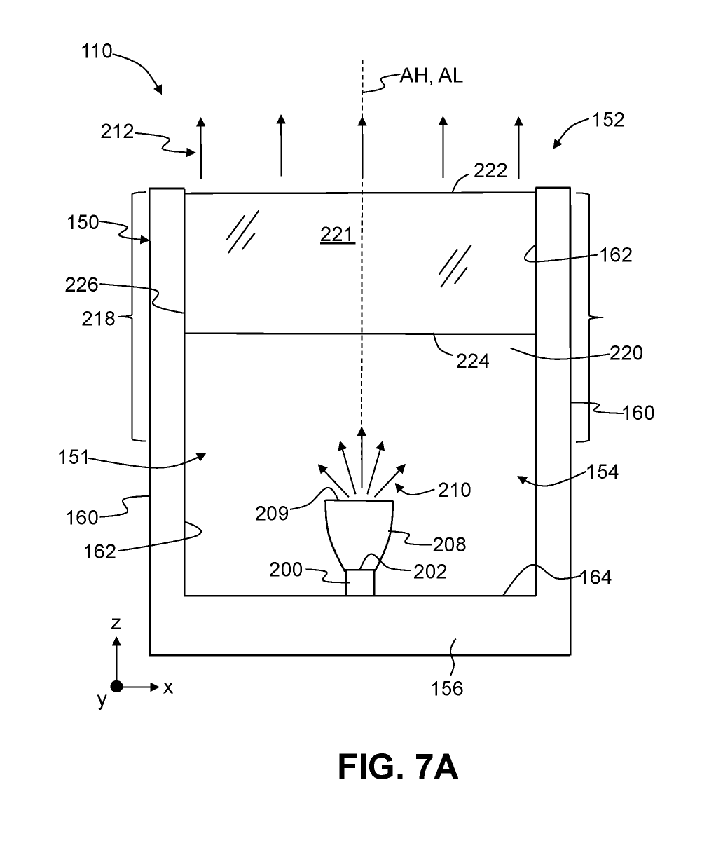

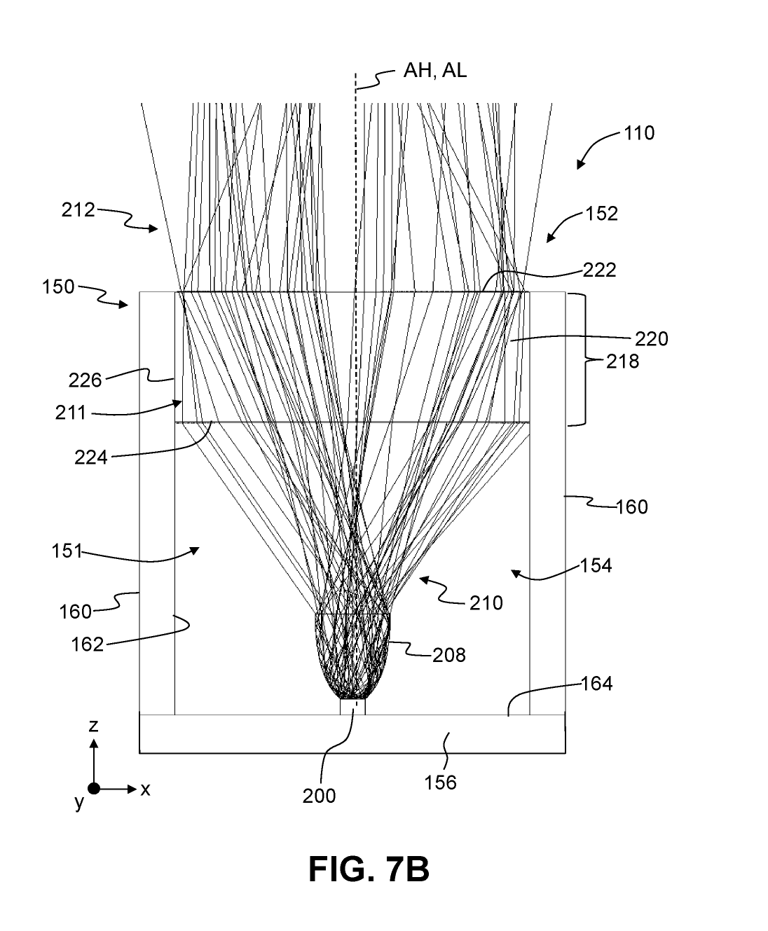

FIG. 7A is similar to FIG. 3A and illustrates an example embodiment wherein the light source 200 includes a collector optical system 208 arranged adjacent upper surface 202 of light source 200. The collector optical system 208 has an output end 209. The collector optical system 208 is configured to collect (condense) light 210 emitted from light source 200 and make the light 210 less divergent (i.e., reduce the amount of divergence) upon exiting output end 209. In an example, collector optical system 208 is in the form of a collector mirror, e.g., such as a parabolic reflector or a compound parabolic concentrator. In an example, collector optical system 208 is rotational symmetric about lens axis AL, while in another example includes a plurality (e.g., 4) parabolic sides (i.e., multiple facets). In an example, collector optical system 208 is bonded to light source 200 so that the collector optical system is in optical contact with the light source. The collector optical system 208 can be hollow or solid and can be made from a glass or a polymer. In an example, collector optical system 208 can consist of a single optical component, e.g., a single mirror-type reflector. In an example, collector optical system 208 operates via TIR.

FIG. 7B is similar to FIG. 7A and includes a computer-simulated ray trace of light 210 as it travels from the output end 209 of collector optical system 208 to the output end 152 of the light-emitting unit 110. Note that some of the light rays 212 outputted at output end 152 are divergent and represent scattered light.

The collector optical system 208 as shown in FIGS. 7A and 7B is operating in a “reverse” mode wherein it does not concentrate light entering the larger end but instead acts to condense light 210 entering through the narrower end that resides immediately adjacent upper surface 202 of light source 200. An LED light source 200 has a substantially Lambertian output with a half-angle θ_{D} on the order of 60°. Thus, light 210 from an LED light source 200 is condensed by collector optical system 208 into light having a half angle of θ_{D}=+/−20° or less. Thus, the use of collector optical system 208 can result a smaller width for support structure 150 since light 210 is less divergent. Measurements of light throughput for example light-emitting units 110 indicate that the use of collector optical system 208 can improve light throughput by up to 70% as compared to conventional light-emitting units. Measurements of light throughput for example light-emitting units 110 that do not use collector optical system 208 have improved light throughput by up to 30% as compared to conventional light-emitting units.

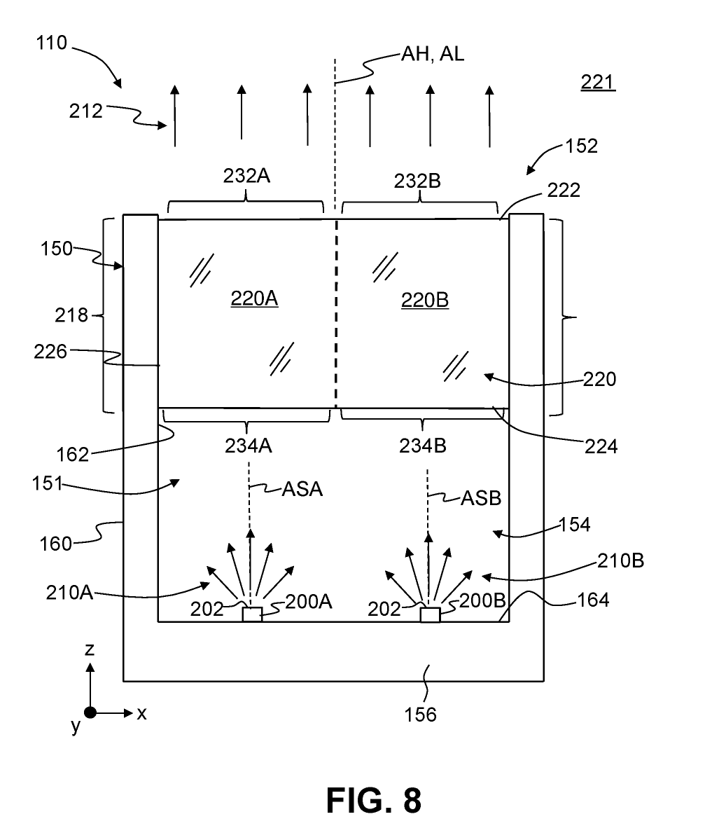

FIG. 8 is similar to FIG. 3A and shows an example embodiment where a single light-emitting unit 110 includes two spaced apart light sources 200, denoted 200A and 200B. Optical system 218 includes the aforementioned upper and lower surfaces 222 and 224, but with each of these surfaces now including respective sets of microstructures 232A, 232B and 234A, 234B that are respectively aligned with the corresponding light source 200A, 200B along respective light source axes ASA and ASB. Thus, in the single-lens example shown in FIG. 8, lens element 220 can be thought of as having two sections 220A and 220B on either side of lens axis AL, with lens section 220A having upper and lower microstructure 232A and 234A and lens section 220B having upper and lower microstructure 232B and 234B. In other examples, more than two light sources 200 can be included in a given light-emitting unit 110, with optical system 218 being configured in corresponding sections 220A, 220B, 220C, . . . to accommodate the given number of light sources.

Optical System Design Considerations

The design of the optical system 218 involves a number of considerations and in an example involves a number of steps. One design consideration involves the choice of lens material and the thickness of the lens material. As noted above, an example lens material is a thermoplastic such as acrylic. This choice of material allows for optical system 218 to be mass-produced with compression or injection molding methods.

The thickness of the at least one lens element 220 is a strong function of the amount of mapping that must take place at lower surface 222 to achieve the desired output uniformity for light 212, with larger amounts of mapping requiring greater lens thicknesses. A rough guide for selecting the lens element thickness is to estimate the largest angle of first redirected light 211 inside the lens element 220 and divide this angle by two. In an example where the divergence angle of light 211 is at most about 25° with respect to the lens axis AL, an example value for the lens element thickness is about 12 mm.

Another step in the design process includes estimating the normalized transition radius ρ_{T} where the microstructure 234 of lower surface 224 changes from being refractive to being both refractive and TIR. To a first approximation, this transition radius ρ_{T} is where the flux from the source outside of the transition plane is equal to the flux from the source inside of the transition plane, just above lower surface 224 and just inside body 221. This means that the transmittance of lower surface 224 must also be taken into account. As noted above, an example location of the transition radius ρ_{T} is in the range 0.6≤ρ_{T}≤0.8, or in the range 0.65≤ρ_{T}≤0.75.

Another step in the design process makes an idealized assumption of a constant transmittance over the lower surface 224. Given this assumption, a design goal of the lower surface 224 is to produce uniform radiant exitance at upper surface 222, as shown in FIG. 5A. An initial selection of microstructure 234 of lower surface 224 is then made based upon the estimated required mapping of light rays 210.

Computer modeling of optical system 218 is then performed using ray tracing to determine the degree of non-uniformity present at upper surface 222 based on first redirected light rays 211. Based on the calculated non-uniformity, the slopes of the micro-prisms 244 of lower surface 224 are adjusted, and the process repeated until the desired uniformity is achieved.

After a good uniformity is obtained at upper surface 222 (or just below this surface), then good uniformity may also be made for light 212 outputted at the upper surface (e.g., at a plane just above this surface), while at the same time such uniform light also may be collimated. Given knowledge of the mapping function (i.e., the angle of incidence) of the first redirected light 211 incident on the upper surface 222 at each micro-prism 242 thereon, the microstructure 232 can be incorporated into the computer modeling. Because the slopes of the micro-prisms 242 of microstructure 232 vary across the upper surface 222, the transmittance will vary as well and the output light will become non-uniform.

After the non-uniformity of the outputted light 212 is characterized, the slopes of the micro-prisms 244 of microstructure 234 of lower surface 224 are adjusted, and another ray tracing is performed. If the collimation of the output light 212 is reduced, then the slopes of micro-prisms 242 of microstructure 232 of upper surface 222 are adjusted and another ray tracing performed. This cycle of adjusting the slopes of micro-prisms 242 and 244 is repeated until the desired degree of output uniformity and collimation in the output beam 212 is obtained.

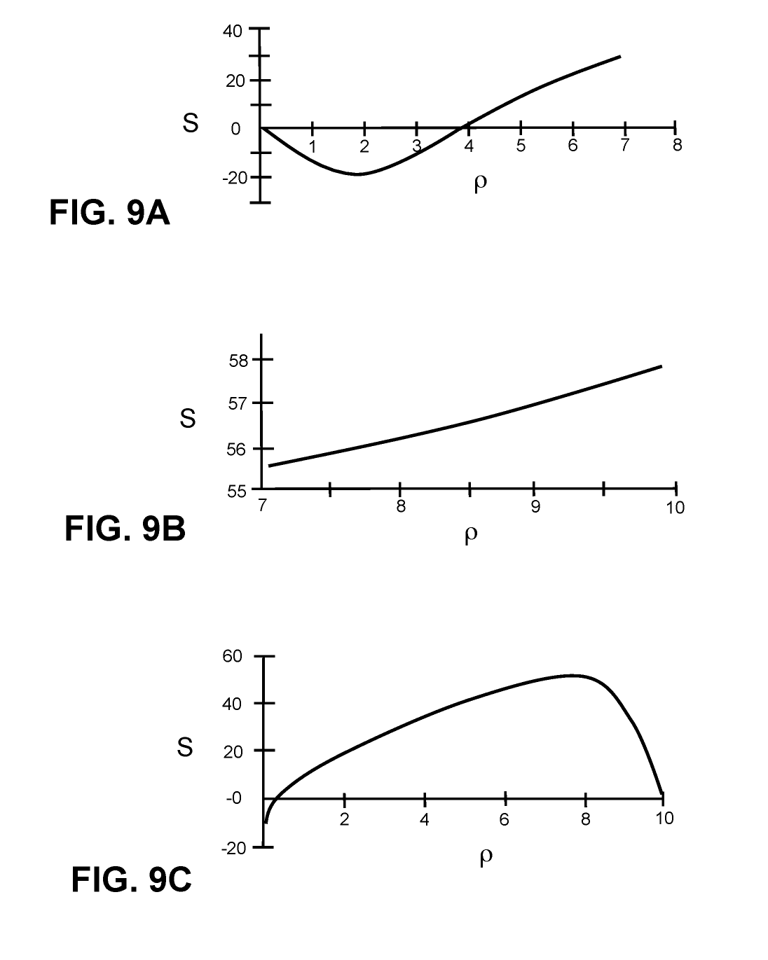

By way of example, the slopes S of the refracting micro-prisms 244 of lower surface 224 can be described by an eighth-order polynomial having the following coefficients:

| | |
|---|---|
| LSR0 | 1.211227203 |
| LSR1 | −21.30518573 |
| LSR2 | 7.863023168 |
| LSR3 | −3.811696165 |
| LSR4 | 2.692908578 |
| LSR5 | −0.89742075 |
| LSR6 | 0.147810393 |
| LSR7 | −0.012061359 |
| LSR8 | 3.92E−04 |

where the slope S (in degrees) is given by S=LSR0+LSR1ρ+LSR2ρ²+LSR3ρ³ . . . +LSR8ρ⁸, where ρ represents the magnitude of the normalized radial coordinate and lies between 0 and 1. FIG. 9A is a plot of the slope S (degrees) versus the normalized radial coordinate ρ for the refractive micro-prisms 244 based on the eight-order polynomial.

Likewise, the slopes of the refractive and TIR micro-prisms 244 of lower surface 224 can be described by a third-order polynomial having the following coefficients:

| | |
|---|---|
| LST0 | 62.75458920 |
| LST1 | −3.23910986 |
| LST2 | 0.38478709 |
| LST3 | −0.01139077 |

where the slope S (in degrees) is S=LSR0+LSR1ρ+LSR2ρ²+LSR3. FIG. 9B is similar to FIG. 9A but for the slopes of the refractive and TIR micro-prisms 244 based on the third-order polynomial.

Also in an example, the slopes S of the micro-prisms 242 of upper surface 222 can be described by a fourteenth-order polynomial having the following coefficients:

| | |
|---|---|
| US0 | −13.6960641390 |
| US1 | 82.3305952934 |
| US2 | −168.8788638697 |
| US3 | 229.4076243236 |
| US4 | −201.1652004011 |
| US5 | 120.5671458565 |
| US6 | −51.2835440219 |
| US7 | 15.8233831837 |
| US8 | −3.5747356334 |
| US9 | 0.5902542425 |
| US10 | −0.0702785391 |
| US11 | 0.0058616192 |
| US12 | −0.0003242658 |
| US13 | 0.0000106664 |
| US14 | −0.0000001576 |

where the slope S (in degrees) is S=LSR0+LSR1ρ+LSR2ρ²+LSR3 . . . +US14ρ¹⁴. FIG. 9C is similar to FIGS. 9A and 9B and shows the slope S of micro-prisms 242 according to the fourteenth-order polynomial.

In an example, the design of lower surface 224 of optical system 218 takes into account the emission profile of light source 200, the surface area of micro-prisms 244, light lost due to draft surfaces, and the Fresnel reflection and transmittance of the micro-prisms 244, all of which can impact uniformity. As noted above, the emission profile need not be uniform, and as long as it can be adequately characterized, it can be accounted for when designing optical system 218 to output a substantially collimated and substantially uniform light beam 212.

It will be apparent to those skilled in the art that various modifications and variations can be made without departing from the spirit or scope of the disclosure. Accordingly, the disclosure is not to be restricted except in light of the attached claims and their equivalents.

1. A light-emitting unit, comprising:
at least one light source that emits divergent light;
an optical system operably disposed relative to the light source, the optical system comprising a central lens axis and either a single lens element only or first and second spaced apart lens elements only, the optical system further comprising: i) a lower surface adjacent and spaced apart from the light source and that receives the divergent light and forms therefrom first redirected light, and ii) an upper surface that receives the first redirected light and forms therefrom second redirected light;
the lower surface comprising inner and outer regions defined by a normalized transition radius ρ_{T} in the range 0.6≤ρ_{T}≤0.8, wherein the outer region comprises first micro-prisms that both refract and totally-internally reflect the divergent light to form therefrom the first redirected light; and
the upper surface comprising second micro-prisms that receive the first redirected light and form therefrom the second redirected light that is substantially collimated and that has a radiant exitance that is uniform to within +/−8% of an average radiance exitance of the second redirected light.

2. The light-emitting unit according to claim 1, wherein the first micro-prisms of the outer region comprise first outer micro-prisms, and the inner region of the lower surface comprises first inner micro-prisms that operate by refraction only.

3. The light-emitting unit according to claim 1, wherein the inner region of the lower surface is smooth.

4. (canceled)

5. The light-emitting unit according to claim 1, wherein the optical system consists of the single lens element, wherein the single lens element has a monolithic body that defines the upper and lower surfaces,

6. (canceled)

7. The light-emitting unit according to claim 5 wherein:
the monolithic body has an axial length LA in the range 5 mm≤LA≤20 mm and defines a clear aperture CA in the range 12 mm≤CA 100 mm;
the lower surface of the optical system is spaced apart from an upper surface of the light source by a distance DS in the range 5 mm≤DS≤15 mm; and the first and second micro-prisms each has a base with a width WP in the range from 25 μm≤W_{P}≤150 μm.

8-9. (canceled)

10. The light-emitting unit according to claim 1, wherein the divergent light from the light source has an amount of divergence, and the light-emitting unit further comprises a collector optical system operably arranged immediately adjacent the light source and configured to reduce the amount of divergence of the divergent light prior to the divergent light from the light source being incident upon the lower surface.

11. The light-emitting unit according to claim 10, wherein the collector optical system consists of a single collector mirror.

12-13. (canceled)

14. A light-emitting apparatus, comprising:
an array of light-emitting units according claim 1.

15. A display device viewable by a viewer in a viewing space, the display device comprising:
the light-emitting apparatus according to claim 14;
an image display unit operably arranged immediately adjacent the light-emitting apparatus; and
a contrast-enhancement unit operably arranged immediately adjacent the image display unit.

16. The display device according to claim 15, wherein:
the image display unit comprises an array of display pixels;
the contrast-enhancement unit comprises a light-absorbing layer with apertures formed therein and optical elements spaced apart from and respectively axially aligned with the apertures;
the second redirected light from the light-emitting apparatus passes through the display pixels to form display light; and
the display light passes through the optical elements and the apertures of the light-absorbing layer to form contrast-enhanced display light that is transmitted into the viewing space.

17. The display device according to claim 16, wherein the contrast-enhancement unit comprises a glass substrate having upper and lower surfaces, the light-absorbing layer is formed on the upper surface of the substrate, and the optical elements are formed on the lower surface of the substrate.

18. The display device according to claim 15, further comprising a transparent cover operably disposed immediately adjacent the contrast-enhancement unit opposite the image display unit.

19. A light-emitting unit that emits substantially collimated and substantially uniform light, the light-emitting unit comprising:
a support structure having a central support structure axis, an open front end that defines an output end, and an interior open at the open front end and defined by a bottom surface and at least one sidewall;
a light source disposed on or adjacent the bottom surface and that emits divergent light;
a single monolithic lens element arranged in the support structure interior, the lens element comprising:
i) a central lens axis;
ii) a lower surface adjacent and spaced apart from the light source and that receives the divergent light and forms therefrom first redirected light; and
iii) an upper surface that resides at or adjacent the output end and that receives the first redirected light and forms therefrom second redirected light;
the lower surface comprising a first microstructure that includes inner and outer regions that are defined by a normalized transition radius ρ_{T} in the range 0.6≤ρ_{T}≤0.8, wherein the first microstructure within the inner region only refracts the divergent light while the first microstructure within the outer region both refracts and totally-internally reflects the divergent light to form the first redirected light; and
the upper surface comprising a second microstructure that receives the first redirected light and forms therefrom second redirected light that is substantially collimated and that has a radiant exitance that is uniform to within +/−8% of an average radiance exitance of the second redirected light.

20. The light-emitting unit according to claim 19, wherein the first and second microstructure each comprises micro-prisms.

21. The light-emitting unit according to claim 19, wherein the support structure is cylindrical and has either a square or a circular cross-section.

22. The light-emitting unit according to claim 19, further comprising a collector optical system operably arranged immediately adjacent an upper surface of the light source.

23. A light-emitting apparatus, comprising:
an array of the light-emitting units according to claim 19.

24. A display device viewable by a viewer in a viewing space, the display device comprising:
the light-emitting apparatus according to claim 23;
an image display unit operably arranged immediately adjacent the light-emitting apparatus; and
a contrast-enhancement unit operably arranged immediately adjacent the image display unit.

25. The display device according to claim 24, wherein:
the image display unit comprises an array of display pixels;
the contrast-enhancement unit comprises a light-absorbing layer with apertures formed therein and optical elements spaced apart from and respectively axially aligned with the apertures;
the second redirected light from the light-emitting apparatus passes through the display pixels to form display light; and
the display light passes through the optical elements and the apertures of the light-absorbing layer to form contrast-enhanced display light that is transmitted into the viewing space.

26. The display device according to claim 25, wherein the contrast-enhancement unit comprises a glass substrate having upper and lower surfaces, the light-absorbing layer is formed on the upper surface of the substrate, and the optical elements are formed on the lower surface of the substrate.

27. The display device according to claim 25, further comprising a transparent cover operably disposed immediately adjacent the contrast-enhancement unit opposite the image display unit.

28-31. (canceled)
